(19) United States
(12) Patent Application Publication
(10) Pub. No.: US 2022/0391918 A1
(43) Pub. Date: Dec. 8, 2022

(54) COMMUNICATION CHANNEL SYSTEMS AND METHODS

(71) Applicant: Techaum Innovations Pty Ltd, Bella Vista, New South Wales (AU)

(72) Inventors: Venkata Satyabhaskar MADDALA, Bella Vista, New South Wales (AU); Vijay Krishna MENON, Bella Vista, New South Wales (AU); David PALMER, Bella Vista, New South Wales (AU)

(21) Appl. No.: 17/776,966

(22) PCT Filed: Nov. 13, 2020
(86) PCT No.: PCT/AU2020/051234

§ 371 Date: May 13, 2022

(30) Foreign Application Priority Data
Nov. 13, 2019 (AU) 2019904284
Nov. 14, 2019 (AU) 2019904302

(51) Int. Cl. G06Q 30/00; G06N 5/02; H04L 51/066

(52) U.S. Cl. CPC G06Q 30/016; G06N 5/022; H04L 51/066

(57) ABSTRACT

Described embodiments generally relate to a communications system comprising a first message broker configured to receive a request message from a messaging application executed by a customer computing device, the first message broker being a universal message broker adapted to receive messages from a plurality of different messaging applications; a message processing module configured to receive the request message from the first message broker and to interpret the request message to determine a sub-system of a vendor computing system to which the request message is directed; a first formatter configured to receive the request message from the message processing module, and to format the request message to match the format expected by the determined sub-system; and a second message broker configured to receive the formatted message from the first formatter and to send the formatted message to the determined sub-system.

### TECHNICAL FIELD

Embodiments generally relate to systems and methods for providing communication channels between customers and vendors. Specifically, embodiments relate to systems, devices and methods for facilitating automated real time communication between customers and vendors.

### BACKGROUND

While the number of channels for long distance communication continues to grow, many customers find that vendors for goods and services, such as airlines, are limited in the communication channels by which they can be reached. For example, a passenger of an airline may find they only have three channels of communication available, being an inbound phone call to a customer care or call centre, outbound SMS messaging from the airline, and a self-service application provided by the airline website. However, these communication channels have limited functionality, tend to be time consuming to use, and may compromise the privacy and security of the passenger.

It is desired to address or ameliorate one or more shortcomings or disadvantages associated with prior systems and methods for communication channels between customers and vendors, or to at least provide a useful alternative thereto.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Some embodiments relate to a communications system comprising:
a first message broker configured to receive a request message from a messaging application executed by a customer computing device, the first message broker being a universal message broker adapted to receive messages from a plurality of different messaging applications;
a message processing module configured to receive the request message from the first message broker and to interpret the request message to determine a sub-system of a vendor computing system to which the request message is directed;
a first formatter configured to receive the request message from the message processing module, and to format the request message to match the format expected by the determined sub-system; and
a second message broker configured to receive the formatted message from the first formatter and to send the formatted message to the determined sub-system.

In some embodiments, the second message broker is further configured to receive a reply message from the determined sub-system and pass the message to a second formatter, the second formatter is configured to format the reply message to match the format expected by the messaging application and pass the formatted message to the first message broker, and the first message broker is configured to send the formatted message to the messaging application executed on the customer computing device.

Some embodiments further comprise at least one vendor sub-system configured to generate the reply message based on the interpretation of the request message generated by the message processing module.

According to some embodiments, the reply message is also based on information relating to an account of the user of the customer computing device. In some embodiments, the reply message is also based on information stored in at least one database of the vendor computing system. According to some embodiments, the reply message is also based on geolocation information received from a GPS module of the consumer computing device.

In some embodiments, the message processing module generates a virtual communication room to facilitate communication between the customer computing device and the vendor computing system.

In some embodiments, the message processing module comprises a plurality of stateless servers. According to some embodiments, the message processing server further comprises a load balancer configured to distribute received messages to the plurality of stateless servers.

In some embodiments, the plurality of stateless servers act as a cloud server.

According to some embodiments, the vendor computing system is operated by an airline and the request message relates to airline services.

According to some embodiments, the plurality of messaging applications include at least two of Facebook Messenger, SMS, WhatsApp, Twitter, Instagram, Skype and WeChat.

In some embodiments, the message processing module comprises at least one of an artificial intelligence module, a machine learning module, or a natural language processing module.

According to some embodiments, the message processing module comprises a set of logic rules for routine messages.

Some embodiments further comprise a security layer configured to authenticate a user account associated with the customer computing device. In some embodiments, the security layer is configured to only route messages to the first message broker if the user account is authorised.

According to some embodiments, the message processing module is configured to interpret the request message by analysing the message using at least one binary classifiers to determine whether or not the message relates to at least one message class, and, if the message does belong to at least one message class, determining the sub-system of the vendor computing system to which the request message is directed by matching the at least one message class to the sub-system.

Some embodiments relate to a method of facilitating communication between a customer computing device and a vendor computing system, the method comprising:
receiving, at a first message broker, a request message from a messaging application executed by a customer computing device, the first message broker being a universal message broker adapted to receive messages from a plurality of different messaging applications;
interpreting the request message to determine a sub-system of a vendor computing system to which the request message is directed;
formatting the request message to match the format expected by the determined sub-system; and
sending the formatted message to the determined sub-system.

Some embodiments further comprise receiving a reply message from the determined sub-system, formatting the reply message to match the format expected by the messaging application, and sending the formatted message to the messaging application.

Some embodiments further comprise generating the reply message based on the interpretation of the request message.

According to some embodiments, the reply message is also based on information relating to an account of the user of the customer computing device. In some embodiments, the reply message is also based on information stored in at least one database of the vendor computing system.

Some embodiments further comprise receiving geolocation information from a GPS module of the consumer computing device, wherein the reply message is also based on the received geolocation information.

Some embodiments further comprise the first message broker determining an originating messaging application from which the request message is received and storing information relating to the messaging application in a database, the method further comprising reading the information stored in the database to determine the messaging application for sending the reply message.

Some embodiments further comprise generating a virtual communication room to facilitate communication between the customer computing device and the vendor computing system.

According to some embodiments, the vendor computing system is operated by an airline and the request message relates to airline services.

In some embodiments, the plurality of messaging applications include at least two of Facebook Messenger, SMS, WhatsApp, Twitter, Instagram, Skype and WeChat.

Some embodiments further comprise authenticating a user account associated with the customer computing device, and only routing messages to the first message broker if the account is authorised.

Some embodiments further comprise storing all received messages in a log.

According to some embodiments, interpreting the request message comprises analysing the message using at least one binary classifiers to determine whether or not the message relates to at least one message class, and, if the message does belong to at least one message class, determining the sub-system of the vendor computing system to which the request message is directed by matching the at least one message class to the sub-system.

Some embodiments relate to a method for facilitating real time communication channel between a customer computing device and a communication module of a vendor computing system, the method comprising:
receiving, at the vendor computing system, a request from the customer computing device, the request including a unique identifier of a user account associated with a user of the customer computing device, the user account being an account held with aa vendor affiliated with the vendor computing system;
based on the user account, retrieving account information;
based on the account information, determining the resource to be provided to the user of the customer computing device;
providing access to a communication channel associated with the resource to the customer computing device; and
communicating with the user via the communication channel in real time.

According to some embodiments, the vendor is an airline and the resource is a flight.

In some embodiments, the communication channel is a messaging application.

According to some embodiments, multiple customer computing devices are provided with access to the communication channel simultaneously, and where each customer computing device is provided with access to only messages between that customer computing device and the vendor computing system.

According to some embodiments, the communication module comprises an artificial conversation entity.

In some embodiments, communicating with the user comprises:
receiving a message from the customer computing device via the communication channel regarding the resource;
interpreting the message using natural language processing;
generating a response to the message; and
sending the response via the communication channel to the customer computing device.

According to some embodiments, interpreting the message comprises determining whether the message comprises a request, and communicating with at least one sub-system of the vendor computing system to determine whether the request can be accommodated.

According to some embodiments, the generated response is based on whether the request can be accommodated.

### BRIEF DESCRIPTION OF DRAWINGS

FIG. 1 is a block diagram of a communication system according to some embodiments;

FIG. 2 is a block diagram showing the communication system of FIG. 1 in further detail;

FIG. 3 is a block diagram showing elements of the chat framework of FIG. 2 in further detail;

FIG. 4 is a flowchart showing a method of communication using the communication system of FIG. 1;

FIG. 5 is a diagram of a data pipeline that may be used by the communication system of FIG. 1;

FIG. 6 is a flowchart illustrating a further method of communication using the communication system of FIG. 1; and

FIG. 7 is a flowchart showing a classification algorithm executed by the communication system of FIG. 1.

### DESCRIPTION OF EMBODIMENTS

Embodiments generally relate to systems and methods for providing communication channels between customers and vendors. Specifically, embodiments relate to systems, devices and methods for facilitating automated real time communication between customers and vendors.

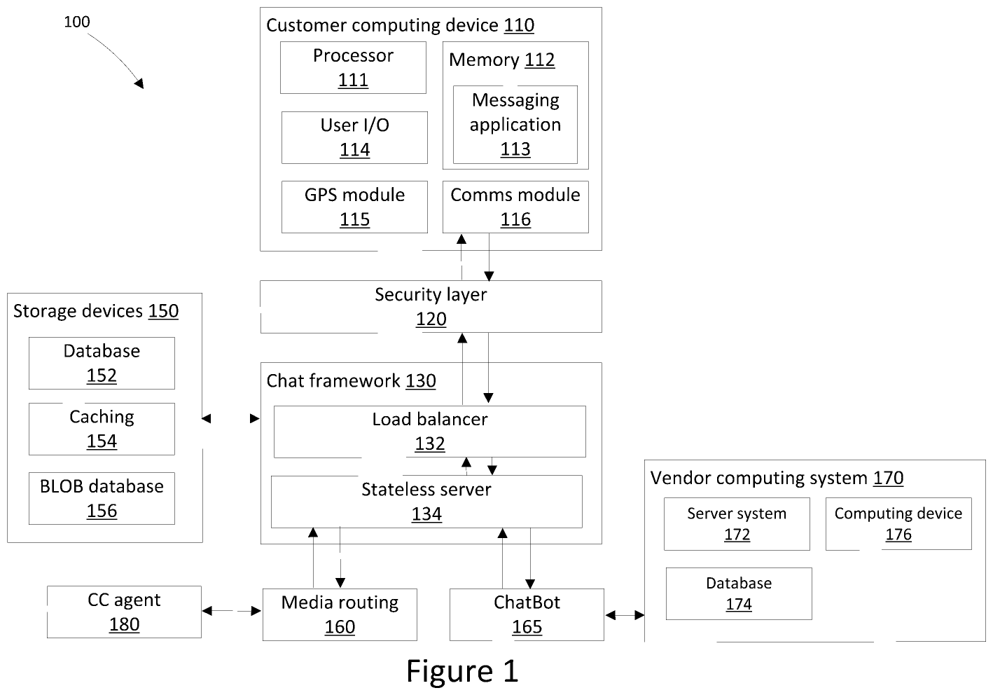

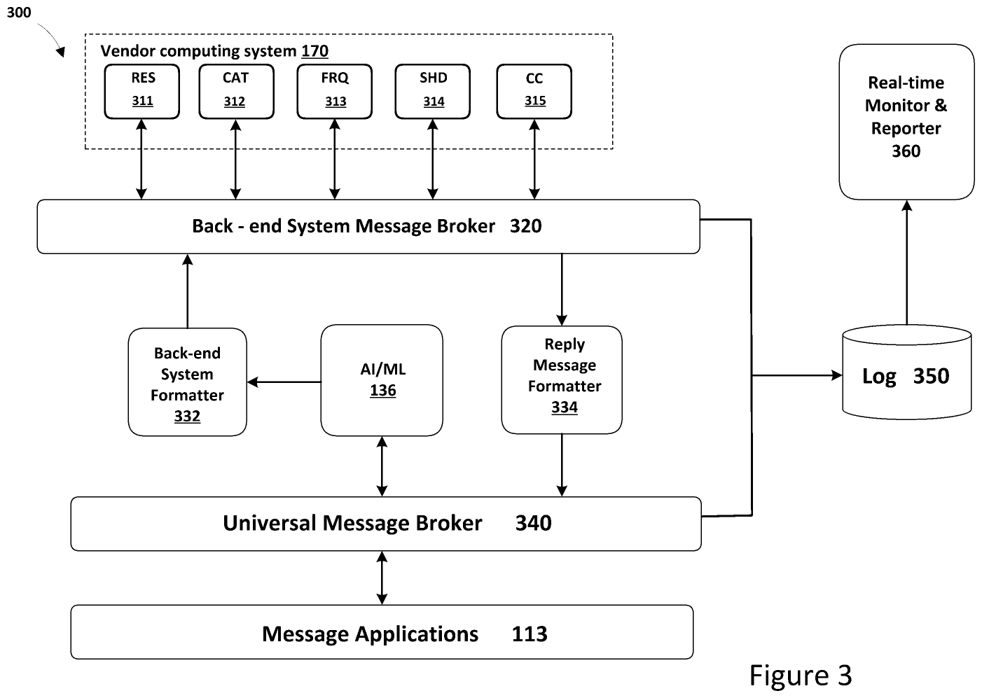

FIG. 1 shows a block diagram of a communication system 100 according to some embodiments. System 100 comprises a customer computing device 110 and a vendor computing system 170. System 100 facilitates real time communication between customer computing device 110 and vendor computing system 170 via a chat framework 130, which provides a virtual communication room to act as a broker between the customer using customer computing device 100 and the vendor using vendor computing system 170, as described in further detail below with reference to FIG. 3.

According to some embodiments, a vendor may be an airline, in which case system 100 may facilitate real time communication between customers operating customer computing devices 110 and the airline operating vendor computing system 170, via existing messaging applications that the customer may already have installed on their customer computing device 110. This allows customers to communicate and chat with airlines operations and customer care in real time and with ease; chat with operations and customer care via a messaging application such as WhatsApp to make requests or changes to their travel booking and flight preferences; get proactive and real time constant personal messages from airlines operations; and receive proactive prompts from airlines confirming any missed preferences such as special diet meals. This information may be retrieved from the customer's travel history and/or frequent flier membership information. Furthermore, system 100 may allow airlines to improve the customer experience of passengers and thereby increase repeat business; increase airline self-service application usage; make it easy for customers to communicate with operations staff and customer care; maintain customer privacy, security and data integrity while interacting with customers/passengers; and communicate proactively and in real time with passengers regarding flight status, passenger status and tracking, and customized alarms during transits.

According to some embodiments, system 100 may alternatively be used by other vendors, which may include vendors in one or more of the banking, finance, health care, hospitality, retail, or utilities industries, for example.

Customer computing device 110 comprises a processor 111 and memory 112 accessible to processor 111. Processor 111 may be configured to access data stored in memory 112, to execute instructions stored in memory 112, and to read and write data to and from memory 112. Processor 111 may comprise one or more microprocessors, microcontrollers, central processing units (CPUs), application specific instruction set processors (ASIPs), or other processor capable of reading and executing instruction code.

Memory 112 may comprise one or more volatile or non-volatile memory types, such as RAM, ROM, EEPROM, or flash, for example. Memory 112 may be configured to store executable applications for execution by processor 111. For example, memory 112 may store at least one messaging application 113. Messaging application 113 may comprise one or more of Messenger, SMS, WhatsApp, Twitter, Facebook, Instagram, Skype and WeChat, for example.

Customer computing device 110 further comprises user input and output peripherals 114 to allow a user to communication with customer computing device 110. User I/O 114 may comprise one or more of a display screen, a touchscreen display, a keyboard, a mouse, a camera, a microphone, a speaker, buttons, sliders, and LEDs. Customer computing device 110 may also comprise other I/O components, such as GPS module 115 which is configured to generate geolocation information, for example.

To facilitate communication via messaging application 113, customer computing device 110 comprises a communications module 116. Communications module 116 may allow for wired and/or wireless communication between customer computing device 110 and external computing devices and components. For example, communications module 116 may facilitate communication via Bluetooth, USB, WiFi, Ethernet, or via a telecommunications network, for example.

Communication between customer computing device 110 and chat framework 130 may be conducted via security layer 120. Security layer 120 may be implemented through the application programming interface (API) layer to act as an API gateway. Security layer 120 may be configured to identify and validate a user identity of a user operating customer computing device 110 to access chat framework 130. Security layer 120 may further be configured to recognise a level of access the user has to information available for access via chat framework 130. According to some embodiments, security layer 120 may be configured to provide permissions for select applications to access particular resources available via chat framework 130 on behalf of a user of consumer computing device 110 without the user needing to provide their credentials to chat framework 130. This may be done by security layer 120 providing an access token to the application on behalf of the user of consumer computing device 110, allowing the application to access the information via the token. According to come embodiments, security layer 120 may be implemented using the OAuth2 protocol.

According to some embodiments, chat framework 130 may be configured to respond to both messages received from authenticated user accounts, and from unknown users. However, the level of information provided by chat framework 130 may vary in these cases.

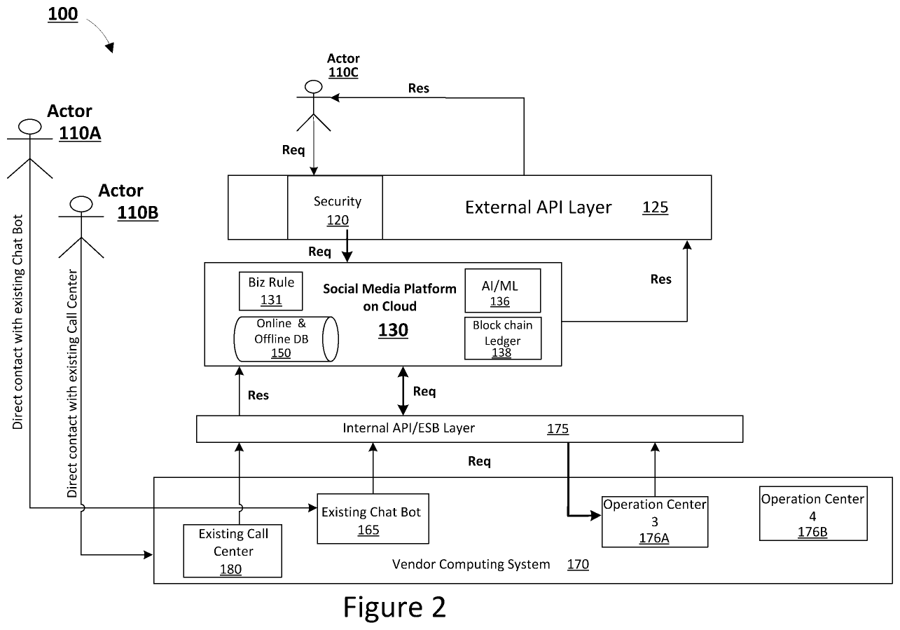

Chat framework 130 comprises a load balancer 132 and at least one stateless server 134. According to some embodiments, chat framework 130 may comprise a plurality of stateless servers 134. Load balancer 132 may be configured to distribute communications received from customer computing devices 110 to the plurality of stateless servers 134. Communications between customer computing devices 110 and load balancer 132 may be implemented via Websocket, BOSH, or LongPoll HHb communications protocols in some embodiments. The plurality of stateless servers 134 may be configured to act as a cloud server, as described below with reference to FIG. 2.

Communication system 100 further includes storage devices 150 accessible to the chat framework 130 via AIP using micro service architecture. Storage devices 150 may include databases such as database 152, caching database 154, and binary large object (BLOB) database 156, for example. Database 152 may be configured to store structured data, and may be implemented as an SQL database server or as an Oracle database in some embodiments. According to some embodiments, database 152 may be a Cassandra database.

Caching database 154 may act as a cache to allow for fast access to stored data, which may be frequently used data. Caching database 154 may be stored in fast access hardware such as RAM, and may be used in correlation with a software component. Caching database 154 may be configured to increase data retrieval performance by reducing the need to access an underlying slower storage layer. Data stored in caching database 154 may be cached, replicated and partitioned across multiple nodes. Data stored in caching database 154 may be stored in an in-memory data grid, to improve the performance and scalability of applications accessing the database without affecting any relational database management systems (RDBMS). Caching database 154 may be a Redis database in some embodiments.

BLOB database 156 may be configured to store unstructured and semi-structured data, and may be a NoSQL database in some embodiments.

Stateless servers 134 may be configured to process communications received from customer computing devices 110, as described below with reference to FIG. 3. Stateless servers 135 may use an open source messaging service, such as ejabberd, Prosody, or OpenFire, to facilitate communication between customer computing devices 110 and vendor computing system 170. Depending on the communication, stateless servers 134 may pass the communication to a media routing component 160, which may forward the communication to a call centre agent 180 for processing.

Alternatively, state servers 134 may pass the message to a chatbot 165 for processing. Chatbot 165 may be integrated with vendor computing system 170 via the API layer, allowing any action required based on the communication to be passed by chatbot 165 as an instruction to vendor computing system 170. Chatbot 165 may be a software based conversation generator or artificial conversation entity, which may use artificial intelligence and/or natural language programming to process and respond to customer messages in a way that simulates a human conversation. According to some embodiments, chatbot 165 may be a Rocket.Chat, Smooch, PubNub, SendBird, or TalkJS chatbot. Chatbot 165 may facilitate one-to-one chatting between vendor computing system 170 and a customer computing device 110.

Vendor computing system 170 comprises a server system 172, database 174 and computing device 176 for executing any instructions required based on the processed communication. Vendor computing system 170 may use a Smack or XMPP framework in some embodiments. Vendor computing system 170 may comprise more than one server system 172, database 174 or computing device 176, and may comprise a number of computing sub-systems as operated by the vendor. For example, where the vendor is an airline, server system 172 may comprise computing sub-systems such as a reservations sub-system, a catering sub-system, a frequent flyer sub-system, a scheduling sub-system, and a customer care sub-system, for example, as described in further detail below with reference to FIG. 3.

FIG. 2 is a block diagram showing communication system 100 in further detail. System 100 as shown in FIG. 2 comprises multiple customer computing devices 110A, 110B and 110C communicating with different elements of the system 100. Client computing device 110A is communicating with a traditional or existing call centre 180 operated by vendor computing system 170. Client computing device 110B is communicating with a traditional or existing chatbot 165 of vendor computing system 170. However, call centre 180 and chatbot 165 are now in communication with chat framework 130 via the internal API/ESB layer 175, allowing for more sophisticated processing of information and commands received by call centre 180 and chatbot 165, so that requests made by customer computing devices 110A and 110B can be processed by chat framework 130 and passed to an appropriate sub-system of vendor computing system 170 for fulfilment. For example, the request might be processed by chat framework 130 and passed via internal API/ESB layer 175 to an operation centre 176A for fulfilment.

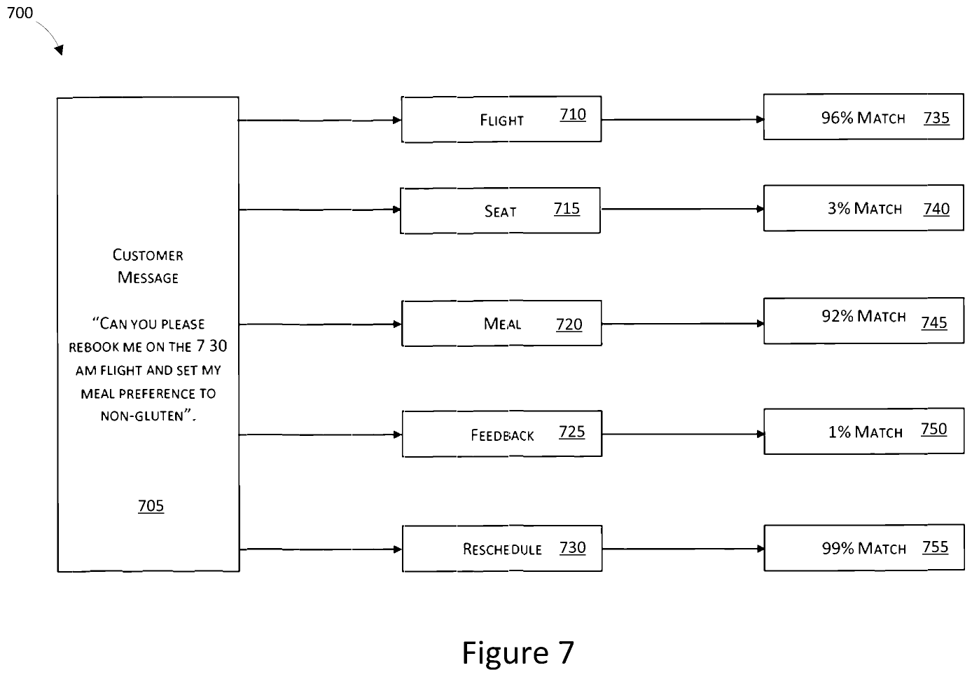

In contrast, customer computing device 110C is in direct communication with chat framework 130 via external API layer 125. External API layer 125 comprises security layer 120, as described above with reference to FIG. 1. Customer computing device 110C may be configured to send messages via one or more messaging applications 113 to vendor computing system 170. The messages are read and interpreted by chat framework 130, as described in further detail below with reference to FIG. 7, which decides which sub-system of vendor computing system 170 should respond to or handle the message, and forwards the message accordingly. Alternatively, sub-systems of vendor computing system 170 may proactively send messages to customer computing device 110C via chat framework 130.

Chat framework 130 of FIG. 2 is implemented as a plurality of stateless servers 134 configured to act as a cloud server. Chat framework 130 may comprise a set of business rules 131 and/or an artificial intelligence or machine learning module 136 for processing customer messages and requests, and for processing data received from vendor computing system 170. Business rules 131 and/or artificial intelligence or machine learning module 136 may act as a message processing module. Chat framework 130 may further comprise storage devices 150 and a block chain ledger 138.

According to some embodiments, business rules 131 may store a series of logic rules for transformation and/or routing, to allow customer requests to be handled and to allow proactive messages to be sent by vendor computing system 170. According to some embodiments, chat framework 130 may include either business rules 131, or machine learning module 136 for handling customer and vendor messages or requests, but not both. According to some embodiments, chat framework 130 may include both business rules 131 and machine learning module 136. Business rules 131 and machine learning module 136 may both be able to access and analyse historic customer data and make meaningful proactive recommendations regarding customer preferences.

Storage devices 150 may comprise database 152, caching database 154 and BLOB database 156 as described above with reference to FIG. 1. According to some embodiments, storage devices 150 may comprise separate databases 152 for online data and for offline data. Online data may include data relating to users of customer computing devices 110 which are currently online in an active state, while offline data may include data relating to users of customer computing devices 110 which are currently offline or in an inactive, dormant state.

FIG. 3 is a block diagram 300 showing elements of the chat framework 130 in further detail. Diagram 300 shows vendor computing system 170 in communication with messaging applications 113 via elements of chat framework 130. Chat framework 130 allows for messages to be sent from messaging applications 113 executed on customer computing devices 110 to sub-systems of vendor computing system 170, and vice versa.

Vendor computing system 170 comprises a number of vendor sub-systems, which may vary according to the goods and/or services that the vendor trades in. In the illustrated example, the vendor may be an airline providing flight services, and vendor computing system 170 comprises a reservations sub-system 311, a catering sub-system 312, a frequent flyer sub-system 313, a scheduling sub-system 314, and a customer care sub-system 315. When a sub-system of vendor computing system 170 sends a message directed to a messaging application executing on a customer computing device 110, the message is first passed to a back-end message broker 320.

Back-end system message broker 320 is configured to log and track outbound messages from the vendor computing system 170, and pass these on to reply message formatter 334. Back-end system message broker 320 is further configured to receive inbound messages from back-end system formatter 332 and pass these to the correct sub-system of vendor computing system 170.

Reply message formatter 334 receives messages from a sub-system of vendor computing system 170 via back-end message broker 320, and is configured to ensure that the message matches the expected format of the target messaging application 113. For example, if it is desirable to send a message to a WhatsApp messaging application executing on a customer computing device 110, reply message formatter 334 may be configured to format any message sent by vendor computing system 170 to a format compatible with the WhatsApp messaging application.

Reply message formatter 334 may further be configured to send the formatted message to universal message broker 340. Universal message broker 340 may be responsible for examining, logging and tracking both inbound and outbound messages between vendor computing system 170 and messaging applications 113, and may provide a broker function to interpret the inbound and outbound messages. Universal message broker 340 may be configured to interpret the messages to determine their format, which may allow universal message broker 340 to identify the origin of the message, such as which messaging application 113 generated the message. Universal message broker 340 may further be configured to maintain a ‘state’ related to the message through the use of control flags that are stored within caching database 154, to ensure that the correct inbound message is replied to by the vendor computing system 170 with a corresponding outbound message in reply. The control flags may comprise unique identifying characters that are sent with the inbound message to ensure that any return replies to the inbound message are sent to the correct messaging application on the correct customer computing device 110. The identifying characters may also comprise a message and reply counter that keeps track of the number of messages received from a customer computing device 110 and responded to by the chat framework 130, by incrementing the counter each time a message is sent or received.

Universal message broker 340 may further be in two-way communication with artificial intelligence or machine learning module 136. Machine learning module 136 may be configured to act as a virtual communication room between the customer and the vendor, and to process messages to direct a request to the correct sub-system of vendor computing system 170 for reply to messages originating from messaging applications 113, or to direct requests back to universal message broker 340 to authenticate or request any further information required to process the message. No data is stored by machine learning module 136, and no customers can see messages sent by other customers, ensuring private communication between the vendor operating vendor computing system 170 and each customer operating customer computing device 110.

Universal message broker 340 is also in two-way communication with messaging applications 113 executing on customer computing devices 110. As described above, messaging applications 113 may comprise one or more of Messenger, SMS, Whatsapp, Twitter, Facebook, Instagram, Skype and WeChat, for example.

When a message originating from a messaging application 113 is received by universal message broker 340, the message is passed to machine learning module 136 for processing and to identify which sub-system of vendor computing system 170 the message is to be directed to. Machine learning module 136 passes the message to back-end system formatter 332, which is configured to format the message to match the expected format of the target vendor sub-system. For example, if it were determined that the target sub-system was scheduling sub-system 314, back-end system formatter 332 would format the message received from messaging application 113 to be compatible with scheduling sub-system 314. Messages that machine learning module 136 cannot understand or cannot select an appropriate sub-system for may be forwarded to call centre 180, as shown in FIG. 2, to be dealt with by a human staff member of the vendor.

Messages received by back-end system message broker 320 and by universal message broker 340 may be logged in log 350. Log 350 may be a database containing all sequential transactions between back-end system message broker 320 and universal message broker 340, containing all inbound messages to vendor computing system 170 sent by messaging applications 113, and all outbound replies sent by vendor computing system 170 to messaging applications 113. According to some embodiments, log 350 may be implemented as a block chain ledger, such as block chain ledger 138 as shown in FIG. 2. Log 350 may be accessible by real-time monitor and reporter 360, which may access the log data to generate corporate real-time, on-screen analytics, monitoring and statistical reporting.

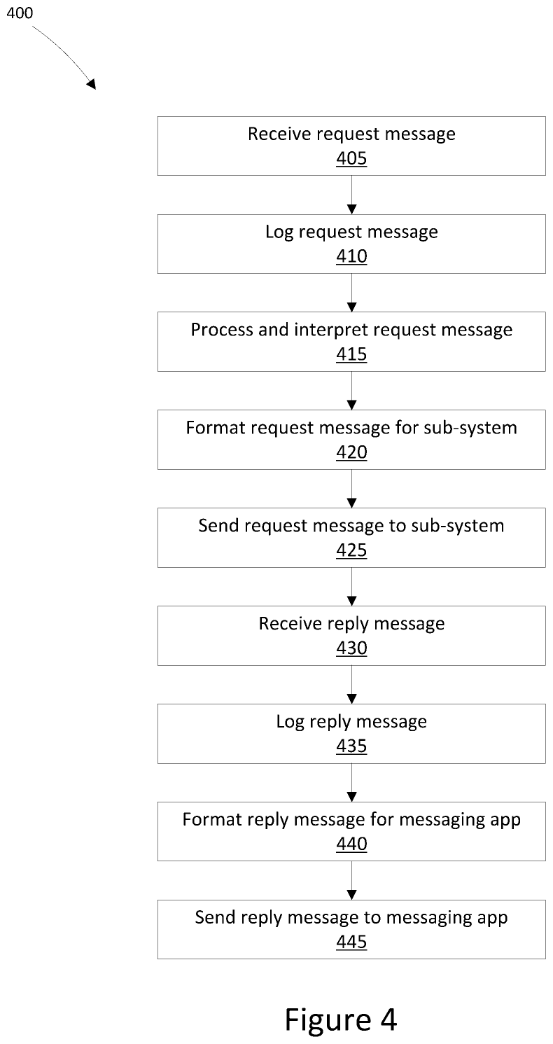

FIG. 4 shows a flowchart illustrating a method 400 of communication using communication system 100, as performed by the components of chat framework 130.

Method 400 begins at step 405 with universal message broker 340 of chat framework 130 receiving a request message sent by a customer using a messaging application 113 executed on a customer computing device 110. At step 410, universal message broker 340 logs the message in log 350, determines the origin of the message, and sets appropriate control flags in caching database 154.

At step 415, universal message broker 340 passes the message to machine learning module 136 for processing and interpretation, as described in further detail below with reference to FIG. 7. Machine learning module 136 interprets the message and determines which sub-system of vendor computing system 170 to pass the message to. Machine learning module 136 then passes the message and the determined sub-system to back-end system formatter 332 at step 420. Back-end system formatter 322 uses the information to format the message into an appropriate form for receipt by the determined sub-system.

At step 425, the message is sent by back-end system message broker 320 to the appropriate sub-system of vendor computing system 170 for appropriate action. The sub-system processes the message and sends a reply, which is received by back-end system message broker 320 at step 430. At step 435, back-end system message broker 320 logs the reply message in log 350. The message is then passed to reply message formatter 334. At step 440, reply message formatter 334 formats the reply message into an appropriate format for receipt by the messaging application 113. Details of the messaging application 113 to be used may be read from caching database 154, having been written to caching database 154 by universal message broker 340 at step 410.

The formatted reply message and is passed to universal message broker 340 which, at step 445, send the reply message to the appropriate messaging application 113.

An example use of system 100 is now described with reference to the steps shown in method 400 of FIG. 4. In the example, system 100 is being used by a customer wishing to communicate with an airline company to change their flight details, where the airline company is the vendor in control of vendor computing system 170. At step 405, universal message broker 340 of chat framework 130 receives a request message sent by the customer using a messaging application 113 executed on a customer computing device 110. In this example, the customer uses Facebook Messenger to send a private message to the airline Facebook page. The message reads “I would like to change the departure date of my flight from Monday to Tuesday.” At step 410, universal message broker 340 logs the message in log 350, and determines that the origin of the message is Facebook Messenger. Universal message broker 340 sets appropriate control flags in caching database 154.

At step 415, universal message broker 340 passes the message to machine learning module 136 for processing and interpretation. Machine learning module 136 interprets the message following method 700 as described in further detail below with reference to FIG. 7, and determines that the message relates to a request to change flight details. Machine learning module 136 determines that the request relates to a change in the departure date of a flight, and should be handled by the reservations sub-system 311. The message is passed to back-end system formatter 332 at step 420, with additional data requesting that the messages is passed to reservations sub-system 311. Back-end system formatter 322 uses the information to format the message into an appropriate form for receipt by reservations sub-system 311. This formatting may comprise matching the message format to a format required for the back-end of reservations sub-system 311 to correctly receive and interpret the message.

At step 425, the message is sent by back-end system message broker 320 to reservation sub-system 311 for appropriate action. Reservation sub-system 311 determines that there is an existing booking for the passenger that departs Amsterdam on Monday 9th April, and retrieves information regarding suitable flights to the same destination that depart on Tuesday 10^{th} April. Reservation sub-system 311 then sends a reply message to the customer confirming which of the Tuesday flights they would like to book. For example, the message may read “Thank you for your request. We can certainly change your flight to Amsterdam from Monday 9^{th} April to Tuesday 10^{th} April. There are three flights available to Amsterdam departing on Tuesday 10^{th} April, being at 9.45 am, 3 pm, and 8.15 pm. Which flight would you like to book?” The message is received by back-end system message broker 320 at step 430. At step 435, back-end system message broker 320 logs the reply message in log 350. The message is then passed to reply message formatter 334. At step 440, reply message formatter 334 formats the reply message into an appropriate format for receipt by the Facebook Messenger.

The formatted reply message and is passed to universal message broker 340 which, at step 445, send the reply message to the customer via Facebook Messenger. The customer may proceed to reply with their selected time, and the method may begin again from step 405.

In another example, the user may first send the message “Can you please change my flight”. As this message does not have details regarding the flight number or the change required, this may require further back and forth messages. For example, machine learning module 136 may interpret the message, determine a user account associated with the customer computing device 110 that sent the message, retrieve flight bookings related to the user account, and send a message back to the customer computing device requesting further information, such as a message saying “I have found the following flight bookings: 1. QF1. SYD-SIN Tue 4 October; 2. QF2. SIN-SYD Fri 7 October; 3. QF495. SYD-MEL Fri 7 October Please reply with the flight you wish to change.” If the customer computing device 110 responds with “Number 3”, machine learning module 136 may be configured to interpret the message, determine alternative flights available and send a message with the alternative flights, such as “OK, here are some later flights during the day to choose from: 1. QF421 departing 9:30 am; 2. QF427 departing 11:00 am; 3. QF445 departing 3:30 pm; 4. QF497 departing 10:05 pm; or reply with a flight number, date & time.” If the customer replies with “Change me to QF421”, machine learning module 136 may be configured to interpret the message, communicate with the sub-systems of vendor computing system 170 to determine whether the request can be accommodated, and, assuming the request can be accommodated, instruct the appropriate sub-systems of vendor computing system 170 to record a change to the booking, then confirm the change with the customer by responding: “Change successful. You are now rescheduled on QF421 departing SYD for MEL at 9:30 am from Terminal 3 (T3)”, for example.

The same method steps may be executed for different example requests from a customer to a vendor. For example, where the vendor is an airline, and the customer has a user account with the airline or has booked a flight with the airline, the user may be able to communicate with the vendor via system 100 to change or add meals to a flight; change or add luggage; extend their transit stay; upgrade their travel class; allow a payment facility such as PayPal to use their phone to pay for upgrades or changes; allow Frequent Flyer points to be used across airlines within an alliance such One World; or request wheelchair assistance. The communication exchange from the user's perspective may be performed entirely via a messaging application 113 of their choice, and may appear to be a text based conversation with a human operator.

Where a customer does not have a user account with the airline, the user may still be able to send messages to vendor computing system 170 with feedback, complaints, or requests for information. For example, a user may be able to send a message via messaging application 130 to an airline with the enquiry “What time does flight QF25 leave tonight?”. Chat framework 130 may be configured to interpret the message, retrieve the relevant information, and respond with “QF25 is scheduled to depart at 9:25 pm tonight.”

System 100 may also be used by an airline to proactively reaching out to customers in transit, such as to actively track the location of customers via GPS module 115 and to send personal notifications to passengers where it seems that a passenger may miss their flight based on their location data. System 100 may subsequently rebook the passenger on a later flight. System 100 may also be used by an airline to use past flight history to advise passengers of a meal choice; to transmit gate information to customers; to provide customers with WiFi details based on their port location; to personalise WiFi details for each customer; to provide immigration details to incoming passengers; to provide customers with a choice of movies based on their past movie choices; provide luggage details, particularly if the customer's luggage did not onboard with the customer; provide customer arrival details to contacts receiving the customer at the arrival port; track customer travel to provide to a nominated contact; market offers and advertising to customers based on customer history; provide customers with an airport guide; handle complaints; provide details of connecting flights if a customer's flight is cancelled or changed; and provide a facility to claim GST and other duty free claims.

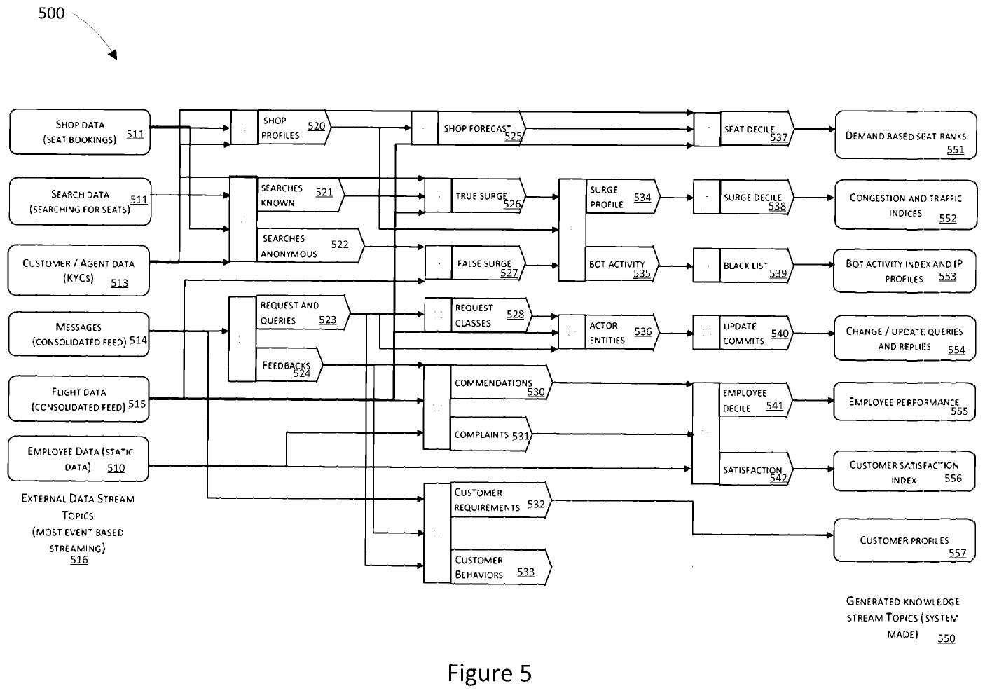

FIG. 5 shows a diagram of a data pipeline 500 that may be used by machine learning module 136 to generate data 550 to be used by system 100 based on known information 510. Machine learning module 136 may use machine learning, artificial intelligence, text mining, and other techniques to generate the data.

For example, machine learning module 136 may be configured to generate demand based seat ranks 551 to shown which seats are in most demand on a particular aircraft, Machine learning module 136 may generate demand based seat ranks 551 based on shop data 511, customer data 513, and flight data 515. Specifically, shop data 511, such as seat bookings, may be combined with customer data 513, such as customer identification data or “know your customer” (KYC) data, to recognise a pattern of seat booking and to profile this data for each known seat to produce shop profiles 520. Shop profiles 520 may be combined with flight data 515 to produce a shop forecast 525, by forecasting booking trends in the near future using predictive analysis. Shop forecast data 525 may be combined with customer data 513 and flight data 515 to produce seat decile data 537, being a multi-parameter decile value that is a measure of the demand for a particular seat at any given time on a particular route. This allows a demand based seat rank 551 to be determined.

Machine learning module 136 may further be configured to generate congestion and traffic indexes 552 and bot activity index and IP profiles 553 based on shop data 511, search data 512, customer data 513, and flight data 515. Search data 512, such as search data relating to seats searched for, is combined with shop data 511 and customer data 513 to produce known searches 521 and anonymous searches 522. Known searches 521 contains data relating to searches performed by known users, while anonymous searches 522 contains data relating to searches performed by anonymous users. Known searches 521 are combined with customer data 513 and flight data 515 to produce true surge data 526, being the real surge in interest. Anonymous searches 522 are combined with flight data 515 to produce false surge data 527, being a stream that allows anomalies and high frequency search patterns to be filtered out from the search data. True surge data 526 and false surge data 527 are combined together and with shop profiles 520 to read booking patterns and produce a surge profile 534 and predicted BOT activity 535. Surge profile 534 is used to generate surge decile 538, being a multi-parameter measure of congestion and surge in the system, which allows for the calculation of congestion and traffic indexes 552. BOT activity 535 is used to generate a black list 539, being a list of suspected sources or predicted BOT attacks, which allows for the calculation of BOT activity index and IP profiles 553.

Machine learning module 136 may further be configured to generate change/update queries and replies 554 based on messages 514 and flight data 515. Messages 514 may be messages generated and sent by messaging applications 113, as described above with reference to FIGS. 1 to 4. Messages 514, which may be in the form of a consolidated feed of messages, are processed and interpreted to generate requests and queries 523 and feedbacks 524. This may be done by way of binary classification of messages received from messaging applications 113 using natural language programming of the messages. Requests and queries 523 may be further processed to determine request classes 528, and the request classes 528 may be combined with requests and queries 523 and flight data 515 to determine actor entities 536. Request classes 528 may be determined based on further natural language processing of the messages and machine learning to determine a type of request. Actor entities 536 may be determined by running an entity recognition task on the request message feed to identify the flight and class relating to the request, and the feasibility of carrying out the request. Actor entities 536 may further generate a message in response to the request. Actor entities 536 may allow for update commits 540 to be generated, which are request messages converted into to database commits after user approval and update of any change status. Update commits 540 further allow for change/update queries and replies 554 to be generated.

Machine learning module 136 may further be configured to generate employee performance 555 and customer satisfaction index 556 to be generated based on messages 514, flight data 515, and employee data 516. Feedbacks 524 are combined with flight data 515 and employee data 516 to generate commendations 530 and complaints 531 by classifying feedback messages as positive or negative. Commendations 530 and complaints 531 are combined with employee data 516 to generate employee decile 541 and satisfaction 542, by determining commendations and complaints made against particular employees and generating a satisfaction index. Employee decile 541 is used to calculate employee performance 555, and satisfaction 542 is used to calculate customer satisfaction index 556.

Machine learning module 136 may further be configured to generate customer profiles 557 based on messages 514. Messages 514 are combined with feedbacks 524 and requests and queries 523 to generate customer requirements 532 and customer behaviours 533, using artificial intelligence to understand customer behaviour and requirements and to proactively anticipate customer needs. Customer requirements 532 and customer behaviours 533 are combined to produce customer profiles 557.

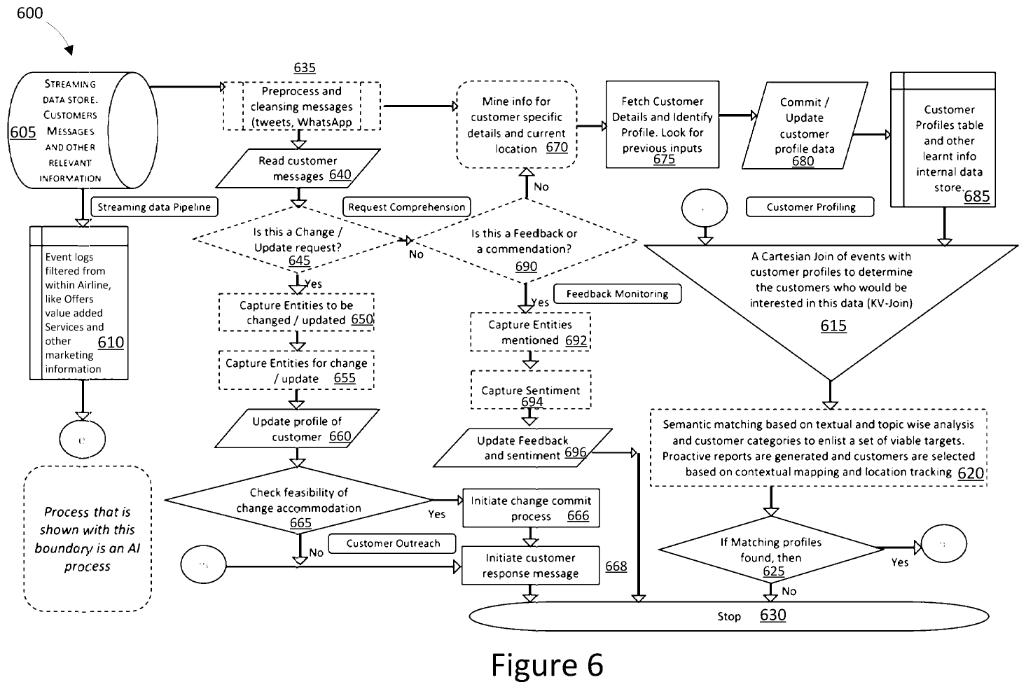

FIG. 6 shows a further flowchart illustrating a method 600 performed by system 100. Method 600 starts at step 605, where messages to and from customers and other information is received by storage devices 150 or other data stores or data pipelines of system 100. Messages and data generated by vendor computing system 170, which is an airline computing system in the illustrated embodiment of FIG. 6, are filtered and extracted at step 610. The filtered data may include offers from the airline to customers, value added services and other marketing information.

This information is then used in conjunction with customer profile information at step 615, to determine which customers may be interested in the offers, services, or other marketing information. At step 620, artificial intelligence based semantic matching is performed by machine learning module 136 based on textual and topic wise analysis of the offers, services and marketing information matched against customer categories, to generate a list of viable target customers to whom the information should be directed. Machine learning module 136 may generate proactive reports based on the semantic matching, and target customers may be selected based on contextual mapping of customer information to offers and services, and based on location tracking of the customers, which may be performed based on geolocation data generated by GPS modules 115 and received from customer computing devices 110.

At step 625, machine learning module 136 determines whether matching profiles were found. If no matching profiles were found, then the method stops at step 630. If matching profiles were found, then a customer response message is initiated at step 668. The message may be passed to chat framework 130 for processing and formatting, to be sent to a messaging application 113 executing on customer computing device 110. The method then stops at step 630.

Steps 610, 615, 620 and 625 may be performed as part of a customer outreach process performed by machine learning module 136.

Returning to step 605, messages and data generated by customer computing devices 110 are also filtered and extracted, and at step 635 these messaged are pre-processed and cleansed by machine learning module 136. The messages are read at step 640, and at step 645 machine learning module 136 determines whether the message relates to a change or update request. If the message does relate to a change or update request, then at step 650 machine learning module 136 extracts the entities to be changed or updated. The entities may be fields stored in a database of vendor computing system 170, such as database 174, and may relate to a good or service provided from the vendor to the customer. For example, where the vendor is an airline, entities may include travel dates, baggage requests, meal choices, and other information relating to a flight booked by the customer with the airline.

At step 655, machine learning module 136 captures the entities for change or update, and the entity information is updated with respect to the customer profile of the customer making the request at step 660. At step 665, the feasibility of accommodating the customer request is determined. If the change cannot be accommodated, then a message informing the customer of this is sent to the customer computing device 110 at step 668, and the method stops at step 630. If the change can be made, a change commit process is initiated at step 666, causing the appropriate database or databases 174 holding the information to be changed to be modified to reflect the change. A message is then sent to the customer computing device 110 informing them of the change at step 668, and the method stops at step 630.

Steps 635, 640, 645, 650, 655, 660, 665, 666 and 668 may form part of a request comprehension process performed by machine learning module 136.

Returning to step 645, if the customer message did not relate to a change or request, at step 690 machine learning module 136 determines whether the message relates to feedback or commendations. If the message does relate to feedback or commendations, then at step 692 machine learning module 136 captures any entities mentioned in the message, which may be employees of the vendor, for example. At step 694, machine learning module 136 captures a sentiment of the message, such as whether the message was positive or negative. The feedback and/or sentiment are then updated and stored in a database of vendor computing system 170 at step 696, and the method stops at step 630.

Steps 690, 692, 694 and 696 may form part of a feedback monitoring process performed by machine learning module 136.

If the customer message was determined at step 690 not to relate to feedback or commendations, then at step 670 the message is mined by machine learning module 136 for customer specific details, and a current location of the customer, which may be provided via GPS module 115 of customer computing device 110. At step 675, the details of the customer are fetched from database 174 and the customer profile is identified. Previous interaction with the customer are extracted. At step 680, customer profile data is updated with the new message information, and at step 685 the customer profile table and other information is stored in database 174 within vendor computing system 170. The method then continues from step 615 to determine whether any offers, services or other marketing information should be provided to the customer.

Steps 670, 675, 680 and 685 may form part of a customer profiling process performed by machine learning module 136.

FIG. 7 shows a flowchart illustrating a method 700 of interpreting messages received by chat framework 130 from messaging applications 113 executing of customer computing devices 110. Method 700 may be executed by machine learning module 136 as part of step 415 of method 400, and may be a non-exclusive multiclass organisation method in some embodiments.

Messaged received by chat framework 130 can be considered an imbalanced dataset from a machine learning perspective, as there are not an even number of messages received for each request type, meaning the computer may not be as well “trained” in detecting certain scenarios and message types as others. One way of dealing with imbalanced data sets when using artificial intelligence or machine learning is to use anomaly detection, where the machine trains on what is normal, and generates an alert if there is a perturbation in the normalcy pattern. The machine may also be able to generate a confidence level regarding how far from the normalcy pattern the anomaly is. This can provide a binary output with a confidence level for a particular analysis.

As a single message received by chat framework 130 might have multiple requirements, multiple trained machines within machine learning module 136 can be used to interpret the message and understand the request the customer wished to make. Each machine may operate as a binary classifier, operating in parallel to classify the message to a plurality of request types.

At step 705, a customer message is received by machine learning module 136. In the illustrated example, the message reads “Can you please rebook me on the 7 30 am flight and set my meal preference to non-gluten”. Steps 710 to 730 are performed by machine learning module 136 in parallel, each step being performed by a separate trained machine within machine learning module 136 operating as a binary classifier.

At step 710, machine learning module 136 parses the customer message to determine whether the message relates to a flight request, such as a request for a departure time or other flight information, for example. At step 735, machine learning module 136 determines that the message is a 96% match to a flight request.

At step 715, machine learning module 136 parses the customer message to determine whether the message relates to a seat request, such as a request for a particular seat on a given flight. At step 740, machine learning module 136 determines that the message is a less than 3% match to a seat request.

At step 720, machine learning module 136 parses the customer message to determine whether the message relates to a meal request, such as a customer asking for a particular meal type. At step 745, machine learning module 136 determines that the message is a 92% match to a meal request.

At step 725, machine learning module 136 parses the customer message to determine whether the message relates to feedback, such as feedback relating to an employee. At step 750, machine learning module 136 determined that the message is a less than 1% match to feedback.

At step 730, machine learning module 136 parses the customer message to determine whether the message relates to a reschedule request, such as a request to reschedule a flight to a later time. At step 755, machine learning module 136 determines that the message is a 99% match to a meal request.

According to some embodiments, machine leaning module 136 makes a binary determination for each message category as to whether the message relates to that message category. The determination may be based on whether the match percentage exceeds a threshold. For example, according to some embodiments, a message is determined to relate to a message category if it has a greater than 50% match with that category. According to some embodiments, a message is determined to relate to a message category if it has a greater than 60%, 70%, 80%, or 90% match with that category.

Based on method 700, machine learning module 136 interprets the message as being related to a flight request, meal request and reschedule request, and causes the requests to be forwarded to the appropriate sub-systems of vendor computing system 170, such as the reservation sub-system 311, catering sub-system 312 and scheduling sub-system 314, for example.

According to some embodiments, method 700 may be implemented by the following algorithm:

```
Algorithm NEMO (D, N)
D <− dataset
N <− corresponding list of class labels for each datum in D
  T <− unique(N)
  for tᵢ ε T
    dᵢ <− (sₚ, sₙ), sₚ, sₙ ⊂ D
    pᵢ ε sₚ if pᵢ ε tᵢ
    qᵢ ε sₙ if qᵢ ε tⱼ, i≠j
    mᵢ <− train ( dᵢ )
    accᵢ <− test(mᵢ)
    (mᵢ, accᵢ) ε M
end for
```

In the above algorithm, D is the complete dataset of messages, and N is a list of arrays of labels for each datum D. T is the set of all unique labels made from N. For each label t in T, a set d is created with positive and negative samples. All positive samples from the s set are chosen to make set p, and the same number of negative samples from the s set are chosen to make set q. The binary model m is trained on the data, and the accuracy of model m is tested on an unseen test set. Once complete, the model m and the determined accuracy of model m are added to the set of models M.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A communications system comprising:
a first message broker configured to receive a request message from a messaging application executed by a customer computing device, the first message broker being a universal message broker adapted to receive messages from a plurality of different messaging applications;
a message processing module configured to receive the request message from the first message broker and to interpret the request message to determine a sub-system of a vendor computing system to which the request message is directed;
a first formatter configured to receive the request message from the message processing module, and to format the request message to match the format expected by the determined sub-system; and
a second message broker configured to receive the formatted message from the first formatter and to send the formatted message to the determined sub-system.

2.-40. (canceled)

41. The communication system of claim 1, wherein the second message broker is further configured to receive a reply message from the determined sub-system and pass the message to a second formatter, the second formatter is configured to format the reply message to match the format expected by the messaging application and pass the formatted message to the first message broker, and the first message broker is configured to send the formatted message to the messaging application executed on the customer computing device.

42. The communication system of claim 41, further comprising at least one vendor sub-system configured to generate the reply message based on the interpretation of the request message generated by the message processing module.

43. The communication system of claim 1, wherein the message processing module generates a virtual communication room to facilitate communication between the customer computing device and the vendor computing system.

44. The communication system of claim 1, wherein the message processing module comprises a plurality of stateless servers.

45. The communications system of claim 44, wherein the message processing server further comprises a load balancer configured to distribute received messages to the plurality of stateless servers.

46. The communication system of claim 44, wherein the plurality of stateless servers act as a cloud server.

47. The communication system of claim 1, wherein the vendor computing system is operated by an airline and the request message relates to airline services.

48. The communication system of claim 1, wherein the message processing module comprises at least one of an artificial intelligence module, a machine learning module, or a natural language processing module.

49. The communication system of claim 1, wherein the message processing module comprises a set of logic rules for routine messages.

50. The communication system of claim 1, further comprising a security layer configured to authenticate a user account associated with the customer computing device.

51. The system of claim 1, wherein the message processing module is configured to interpret the request message by analysing the message using at least one binary classifiers to determine whether or not the message relates to at least one message class, and, if the message does belong to at least one message class, determining the sub-system of the vendor computing system to which the request message is directed by matching the at least one message class to the sub-system.

52. A method of facilitating communication between a customer computing device and a vendor computing system, the method comprising:
receiving, at a first message broker, a request message from a messaging application executed by a customer computing device, the first message broker being a universal message broker adapted to receive messages from a plurality of different messaging applications;
interpreting the request message to determine a sub-system of a vendor computing system to which the request message is directed;
formatting the request message to match the format expected by the determined sub-system; and
sending the formatted message to the determined sub-system.

53. The method of claim 52, further comprising receiving a reply message from the determined sub-system, formatting the reply message to match the format expected by the messaging application, and sending the formatted message to the messaging application.

54. The method of claim 53, further comprising generating the reply message based on the interpretation of the request message.

55. The message of claim 53, further comprising the first message broker determining an originating messaging application from which the request message is received and storing information relating to the messaging application in a database, the method further comprising reading the information stored in the database to determine the messaging application for sending the reply message.

56. The method of claim 52, further comprising generating a virtual communication room to facilitate communication between the customer computing device and the vendor computing system.

57. The method of claim 52, wherein the vendor computing system is operated by an airline and the request message relates to airline services.

58. The method of claim 52, further comprising authenticating a user account associated with the customer computing device, and only routing messages to the first message broker if the account is authorised.

59. The method of claim 52, wherein interpreting the request message comprises analysing the message using at least one binary classifiers to determine whether or not the message relates to at least one message class, and, if the message does belong to at least one message class, determining the sub-system of the vendor computing system to which the request message is directed by matching the at least one message class to the sub-system.
